(19) United States
(12) Patent Application Publication
(10) Pub. No.: US 2011/0005771 A1
(43) Pub. Date: Jan. 13, 2011

(54) PFPE OILS IN ESP MOTORS, PROTECTORS AND POTHEADS

(75) Inventors: Arthur I. Watson, Sugar Land, TX (US); John Lee Yoon Kion, Singapore (SG); Melissa Ver Meer, Shawnee, KS (US)

Correspondence Address: SCHLUMBERGER RESERVOIR COMPLETIONS, 14910 AIRLINE ROAD, Bldg. 14, ROSHARON, TX, 77583, US

(73) Assignee: SCHLUMBERGER TECHNOLOGY CORPORATION, SUGAR LAND, TX (US)

(21) Appl. No.: 12/647,930

(22) Filed: Dec. 28, 2009

Related U.S. Application Data
(60) Provisional application No. 61/141,480, filed on Dec. 30, 2008.

(51) Int. Cl. E21B 43/00; F04B 47/06; F04B 35/04; B23P 11/00

(52) U.S. Cl. 166/369; 417/423.3; 417/423.14; 29/428

(57) ABSTRACT

An electrical submersible pump (ESP) for use in a wellbore includes a submersible pump; a motor; and a protector operatively coupled to the motor to protect the motor, wherein at least one of the motor and protector is filled with a PFPE oil. A method for manufacturing an ESP for use in a wellbore includes assembling the ESP from a pump, a motor, and a protector, wherein the protector is operatively coupled to the motor for the protection of the motor; and filling at least one of the motor and protector with a PFPE oil. A method for pumping a fluid from a wellbore using an ESP includes disposing the ESP in the wellbore; and operating the ESP, wherein the ESP comprises a pump, a motor, and a protector, and wherein at least one of the motor and protector is filled with a PFPE oil.

### CROSS-REFERENCE TO RELATED APPLICATIONS

This application claims the benefit of U.S. Provisional Patent Application Ser. No. 61/141,480 filed on Dec. 30, 2008. The disclosure of this provisional application is incorporated by reference in its entirety.

### BACKGROUND OF INVENTION

1. Field of the Invention

The invention relates generally to artificial lift devices and methods, and more specifically, to Electric Submersible Pumps (ESP) and methods for lubricating and protecting ESP.

2. Background Art

In oil wells and the like from which the production of fluids is desired, a variety of fluid lifting systems have been used to move the fluids to surface holding and processing facilities. Electric submersible pump (ESP) is a common equipment used to pump the subterranean formation fluids to surface for transport to processing locations.

FIG. 1 shows a conventional pumping system 10 disposed in a wellbore. The pumping system 10 typically includes at least an electric submersible pump 12 (such as a centrifugal pump), a submersible motor 14, and a motor protector 16. Because the wellbore fluids usually contain deleterious substances, such as muds, sands, barite, and similar particulate and non particulate matters, the main purpose of the protector 16 is to protect the motor 14 by preventing the well fluids from entering the motor 14. In addition to functioning as a seal, the protector 16 also serves as an oil reservoir and pressure equalizer for the motor 14 to balance the internal pressure of the motor 14 with respect to the outside pressure in the wellbore.

The pumping system 10 is deployed in a well 18 penetrating a geological formation 20 containing desirable production fluids, such as petroleum. In a typical application, a wellbore 22 is drilled and lined with a casing 24. The casing 24 may include a plurality of openings 26, through which production fluids can flow into the wellbore 22.

The pumping system 10 is deployed in the wellbore 22 by a deployment system 28, which may have a variety of forms and configurations. For example, the deployment system 28 may include tubing 30 connected to the pump 12 by a connector 32. Power is provided to the submersible motor 14 via a power cable 34 coupled to a submersible component, e.g., the motor 14, by a power cable connector or a pothead 35. The motor 14, in turn, powers the centrifugal pump 12, which draws production fluid in through a pump intake 36 and pumps the production fluid to the surface via the tubing 30.

A submersible pump motor often contains an internal motor fluid that is protected from the surrounding well fluid. In addition, the submersible motor is exposed to substantial differential pressures between its interior and the surrounding environment during movement downhole and during operation downhole. The downhole environment can be very hash, with temperatures higher than 250° C. and pressures higher than 30,000 psi. Therefore, a motor protector is typically coupled to the submersible motor to protect the motor from deleterious wellbore fluids and to balance undue pressure differentials.

Many types of motor protectors have been designed for incorporation into electric submersible pumping systems. The motor protectors typically comprise one or more sections that can change conformation or volume to reduce differential pressure while maintaining a barrier between the internal motor fluid and the surrounding wellbore fluid. For a discussion of ESP protectors, please see U.S. patent application publication No. 2007/0224056, by Watson et al.

Even with protectors, ESP systems are eventually damaged after certain service lives in downhole environments. Typical run lives of electric submersible pumps (ESPs) may be several hundred days, depending on the formations. In very harsh environments, the service lives of ESPs would be expected to be much shorter. Common damages to ESPs may include degradation of elastomers used as seals in motors or protectors. In addition, degradation of the oils used in the motor and/or protector can also shorten the service lives of ESPs.

The moving parts in an ESP motor or protector rely on lubricant oils to maintain proper functions. Generally, either mineral oils or synthetic oils, such as poly-alpha-olefin (PAO) oils, are used in ESP motors and protectors. These mineral and PAO oils are selected for their desirable properties. The following are some properties relevant to ESP motor oils (many of these properties are interrelated):

Dielectric strength—A high dielectric strength, typically 25 KV, may beneficially provide a secondary electrical insulation for the motor windings, terminals and leads. Mineral and PAO oils can provide excellent dielectric strength, when they are new. However, the dielectric strength of these oils would be decreased by bearing wear particles and dissolved water coming from slight ingress of well fluids through worn shaft seals.

Viscosity—Mineral and PAO oils generally have sufficient viscosity to protect the bearings in the motor and protector from wear by establishing an adequate thickness of the oil film separating the bearing components. However, long term exposure to elevated temperature gradually breaks down the viscosity of mineral and PAO oils. For example, the mineral and PAO oils tend to suffer excessive loss of viscosity at temperatures above 550° F.

Lubricity—Mineral and PAO oils can provide sufficient lubricity to the bearings in the motors and protectors to prevent wear by reducing the coefficient of friction between the bearing components when they are not separated by a full fluid film. However, long term exposure to elevated temperature gradually breaks down the lubricity of mineral and PAO oils. For example, most mineral and PAO oils may suffer loss of lubricity at temperatures above 550° F.

Specific gravity—When a specific gravity of oils is distinctly different from the well fluids, it may allow the use of gravity separation chambers in a protector to exclude well fluids from ESP motors. Mineral and PAO oils generally have specific gravities of around 0.82, which is useful for gravity separation from water. However, the gravities of most mineral and PAO oils are very close to the densities of many types of crudes. Therefore, this property of mineral and PAO oils may limit their use in gravity separation chambers in high water-cut wells.

Immiscibility—The oils that is immiscible with well fluids may allow the use of gravity separation chambers to exclude well fluids. Although mineral and PAO oils may be very immiscible with water, they are quite miscible with many types of crudes. Again, this property of mineral and PAO oils would limit their use in gravity separation chambers in high water-cut wells.

Thermal stability—Mineral and PAO oils should retain adequate protection properties during both short-term and long-term exposure to elevated service temperatures to extend ESP life. However, long term exposure to elevated temperature would gradually break down the viscosity and lubricity of mineral and PAO oils. For example, these oils typically suffer excessive loss of viscosity and lubricity at temperatures above 550° F.

Chemical stability—Mineral and PAO oils should not be degraded significantly by slight contamination with well chemicals, such as gases and well fluids, which may migrate through the seals in the motors or protectors. In addition to solubility of water and crude, mineral and PAO oils also react with H₂S, and they carbonize excessively at high temperatures.

Inert to other components—Mineral and PAO oils should not react with other components of the motors and protectors, such as metals, elastomers and polymers, especially at elevated temperature and pressure. However, mineral and PAO oils would attack (degrade) many elastomers at temperatures above 550° F.

Clearly, there is a need for better motor oils having most of these properties described above to improve the range and scope of ESP applications.

### SUMMARY OF INVENTION

One aspect of the invention relates to electrical submersible pumps (ESPs) for use in a wellbore. An ESP in accordance with one embodiment of the invention includes a submersible pump; a motor; and a protector operatively coupled to the motor to protect the motor, wherein at least one of the motor and protector is filled with a PFPE oil.

Another aspect of the invention relates to methods for manufacturing an ESP for use in a wellbore. A method in accordance with one embodiment of the invention includes assembling the ESP from a pump, a motor, and a protector, wherein the protector is operatively coupled to the motor for the protection of the motor; and filling at least one of the motor and protector with a PFPE oil.

Another aspect of the invention relates to methods for pumping a fluid from a wellbore using an ESP. A method in accordance with one embodiment of the invention includes disposing the ESP in the wellbore; and operating the ESP, wherein the ESP comprises a pump, a motor, and a protector, and wherein at least one of the motor and protector is filled with a PFPE oil.

Other aspects and advantages of the invention will be apparent from the following description and the appended claims.

### BRIEF DESCRIPTION OF DRAWINGS

FIG. 1 shows a typical electrical submersible pump (ESP) system disposed in a wellbore.

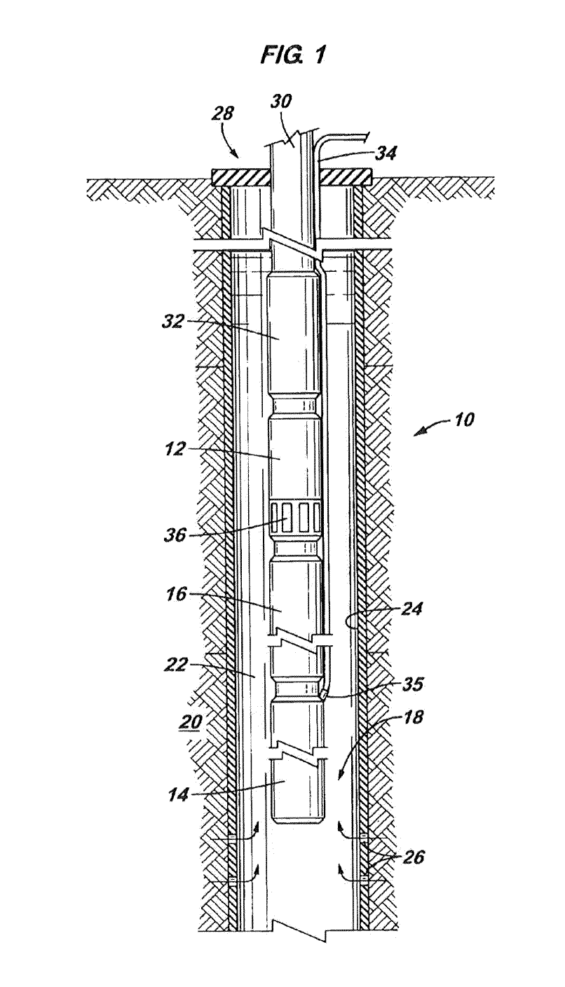

FIG. 2 shows an ESP in accordance with one embodiment of the invention.

FIG. 3 shows an ESP with a sectional view of the protector in accordance with one embodiment of the invention.

FIG. 4 shows an ESP with a power cable and a metal tube attached to a pothead on the motor in accordance with one embodiment of the invention.

FIG. 5 shows a flowchart illustrating a method for making and using an ESP in accordance with one embodiment of the invention.

### DETAILED DESCRIPTION

Embodiments of the invention relate to methods and systems for lubricating and protecting ESP components using Perfluoropolyether (PFPE) oils. The following description concerns a number of embodiments and is meant to provide an understanding of the invention. The description is not meant to limit the scope of the invention.

PFPE oils are clear colorless fluorinated synthetic oils. They are inert, nonflammable, safe, and long lasting. PFPE are also referred to as perfluoroalkylether (PFAE) or pertluoropolyalkylether (PFPAE). They are available from various commercial sources, including Du Pont (Delaware, NJ), Solvay Solexis (Italy), Daikin (Japan), and NOK (Japan). For a review of PFPE oils, see Gregory A. Bell ad Jon Howell, “Perfluoroalkylpolyethers,” in “Synthetics, Mineral Oils, and Bio-Based Lubricants: Chemistry and Technology,” (Leslie R. Rudnick, Editor), Chapter 8, pp. 157-174, CRC Publishing, 2005.

PFPE includes four types of oils that are commercially available. These different types of PFPE oils have similar physical and chemical properties. However, they may have slight differences in their properties due to the difference chemical structures:

PFPE-K CF₃CF₂CF₂O—[CF(CF₃)CF₂—O—]ₙCF₂CF₃

PFPE-Y CF₃O—[CF(CF₃)CF₂—O—]_{y}—[CF₂—O—]ₘCF₃

PFPE-Z CF₃O—[CF₂CF₂—O—])_{y}—[CF₂—O—]ₘCF₃

PFPE-D CF₃CF₂CF₂O—[CF₂CF₂CF₂—O—]ₙCF₂CF₃

wherein n is 10-60, and (y+m) is 10-60. In general, the molecular weights of these PFPE oils are in the range of 435 to 13,500. In addition, PFPE oils may be functionalized to include one or two functional groups attached to the end of the chain. Such functionalized PFPE oils have better anti-corrosion properties and are available from commercial sources. In this description, “PFPE oil” is used in a general sense to include such functionalized PFPE oil or non-functionalized PFPE oil.

The polymer chains in these PFPE oils are completely saturated, and these oils contain only carbon, oxygen, and fluorine. On a weight basis, typical PFPE oils contain about 21.6% carbon, 9.4% oxygen, and 69.0% fluorine.

PFPE oils are superior to mineral and PAO oils in all of the relevant properties discussed above. For example:

Dielectric strength—PFPE oils have higher viscosity and lubricity than mineral and PAO oils. Thus, PFPE oils would produce less bearing and shaft seal wear. Less wear may result in lower contamination of the oils with metal wear particles and well fluids, thereby preserving the dielectric strength of the PFPE oils.

Viscosity—PFPE oils are available in a wide range of viscosities. PFPE oils would lose less viscosity than mineral and PAO oils would, after short-term or long-term exposure to temperatures above 550° F.

Lubricity—PFPE oils would lose less lubricity than mineral and PAO oils would, after short-term or long-term exposure to temperatures above 550° F.

Specific gravity—The specific gravity of PFPE oils is approximately 2. Therefore, they can be easily separated from both water and many types of crudes by gravity separation.

Immiscibility—PFPE oils are immiscible with either water or many types of crudes. This would facilitate their separation from these other fluids.

Thermal stability—PFPE oils break down less than mineral or PAO oils at high temperatures. Therefore, they can provide long-term protection even when used at high temperatures.

Chemical stability—PFPE oils are not attacked by chemicals typically found in oil wells. In addition, their stability makes it possible to recycle the PFPE oils and reuse them after the units have been pulled from the well to offset the costs.

Inert to other components—PFPE oils would not attack elastomers at temperatures above 550° F.

Based on these advantageous properties, embodiments of the invention may include systems and methods that use PFPE oils to improve the performance of ESP components in the following aspects:

(1) PFPE oils may be used for their advantageous dielectric strength, viscosity, lubricity, specific gravity, immiscibility, thermal stability, chemical stability and inertness in motors and protectors to extend the useful life of ESPs at internal temperatures below 550° F., in either vertical or horizontal installations. At below 550° F., PFPE oils still provide superior properties, even though other mineral or PAO oils may also work in these temperature range.

The only known use of PFPE in ESP is in barrier fluid protectors. In barrier fluid protectors, the barrier fluids are be utilized to improve the performance of the motors because they are used only for excluding well fluids. As such, the barrier fluids do not contact the motors at all. Thus, the barrier fluids do not contact the protector bearings or seals. The use of PFPE in ESP motors and protectors, in accordance with embodiments of the invention, expands the use of PFPE oils beyond this known use in ESPs.

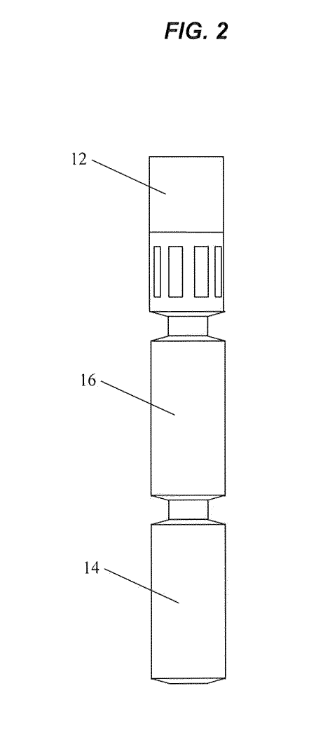

FIG. 2 shows an ESP in accordance with one embodiment of the invention. As shown, a submersible centrifugal pump 12 is operatively coupled to a protector 16, which is operatively coupled to a motor 14. The protector 16 and the motor 14 may be connected in tandem in either vertical or horizontal installations. Either the protector 16 or the motor 14 or both may be filled with PFPE oils. Thus, the protector 16 and the motor 14 may benefit from the superior properties of PFPE with regard to insulation life, bearing life and seal life.

(2) PFPE oils may be used for their advantageous dielectric strength, viscosity, lubricity, specific gravity, immiscibility, thermal stability, chemical stability and inertness in motors and protectors to allow ESPs to perform reliably at internal temperatures above 550° F., in either vertical or horizontal installations. At internal temperatures above 550° F., PFPE oils are much better choice than mineral or PAO oils because mineral and PAO oils tend to degrade at such high temperatures.

This aspect of the invention takes advantage of the unique properties of PFPE oils above 550° F., where the properties of mineral and PAO oils may be very marginal. For example, at temperatures above 575° F., mineral and POA oils may be totally unsuitable. Unlike mineral and POA oils, PFPE oils would not break down and would not attack elastomers at those high temperatures. As shown in FIG. 2, in accordance with embodiments of the invention, the protectors 16 and/or the motors 14 may be filled with PFPE oils.

(3) PFPE, oils may be used for straight gravity separation of well fluids in motors and protectors in relatively vertical wells at any temperature, because of their high specific gravity (density) and immiscibility with well fluids (water or crudes).

This aspect of the invention may eliminate the need for structures, such as reverse gravity separation chambers (labyrinths), rubber bladders (bags), and/or barrier fluid chambers, which are subject to failure. The PFPE oils-filled straight gravity chambers can simplify the construction of protectors.

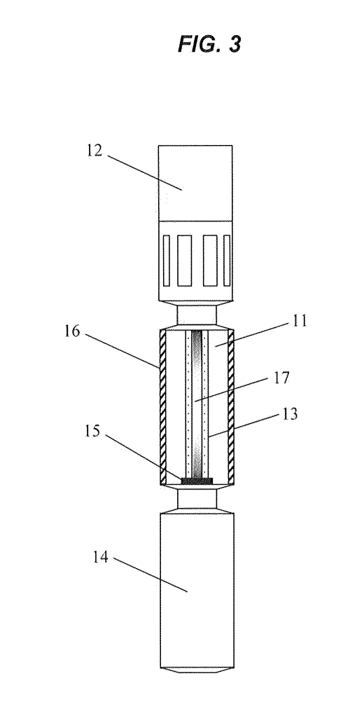

FIG. 3 shows a sectional view of a protector in an ESP system in accordance with one embodiment of the invention. As shown, a submersible centrifugal pump 12 is operatively coupled to a protector 16 (a cross-section view is shown). The protector 16 is operatively coupled to a motor 14. The protector 16 and the motor 14 may be filled with PFPE oils.

The protector 16 has a chamber 11, which may be a simple straight housing of length adequate for the vertical thermal expansion and contraction of the PFPE oils (a straight gravity separation chamber). A shaft tube 13 and a shaft seal 15 may be used to prevent the shaft 17 from imparting rotation to the fluids in the chamber 11. This may avoid mechanical mixing of the PFPE oils with the well fluids, thereby preventing centrifugation of the PFPE oils out of the top of the chamber 11.

Because PFPE oils are much denser than the well fluids, the shaft seal 15 may no longer be critical because any well fluids that leak into the protector 16 may not sink down through the PFPE oils to the motor 14. When the motor 14 heats up, the levels of the RITE oils rise; when the motor 14 cools, the levels of the PFPE oils fall. Thus, the well fluids may be effectively separated from the PFPE oils due to the unique physical properties of the PFPE oils, such as high specific gravity and immiscibility with well fluids.

(4) PFPE oils may be used to exclude well fluids and to pressure balance potheads with motors and protectors in relatively vertical wells at any temperature, because of their high specific gravity.

In accordance with embodiments of the invention, the potheads may feature oil-tilled metal tubes that can be welded to the top end of the potheads and extended over the cables up past the top end of the protectors. These metal tubes may serve to pressure balance the protectors and the motors.

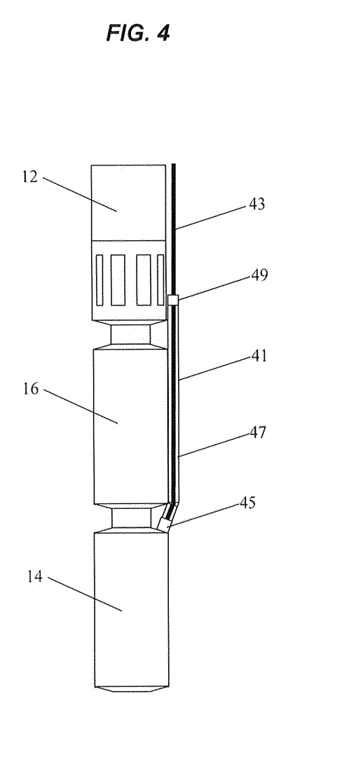

FIG. 4 shows a pumping system, illustrating a pothead attached to a motor, in accordance with one embodiment of the invention. As shown, a submersible centrifugal pump 12 may be operatively coupled to a protector 16. A metal tube 41 may be attached and sealed, as by welding or a tube fitting, to the upper end of a pothead 45, which is attached to the motor 14. A power cable 43 is connected through inside of the metal tube 41 to the motor 14 via the pothead 45. The power cable 43 is disposed in the metal tube 41 to form an annular space 47 between the OD (outside diameter) of the power cable 43 and the ID (inside diameter) of the metal tube 41.

In a vertical wellbore application, the metal tube 41 may extend upward to a height exceeding the height of the protector 16 in the well. The upper end 49 of the metal tube 41 may be open to the wellbore. At installation and before running the ESP into the well, the metal tube 41 may be tilled with PFPE oils. After installation, the protector 16, the motor 14, the pothead 45, and the metal tube 41 effectively act as an “U”-tube, tending to maintain the same level of the PFPE oils in the metal tube 41 and the protector 16. The PFPE oils in the metal tube 41 would prevent well fluids from reaching the pothead 45 because PFPE oils have a much higher specific gravity than well fluids. As a result, if there is any leakage developed in the seals at the pothead 45, the well fluids may not enter the pothead 45 or the motor 14.

The levels of PFPE oils may rise and fall at thermal expansion and contraction, respectively. Because of the “U” tube configuration, although the levels of PFPE oils in the metal tube 41 and the protector 16 may rise and fall according to thermal expansion and contraction, the levels of PFPE oils in the metal tube 41 and the protector 16 may remain the same.

Because the upper end 49 of the metal tube 41 is open to the wellbore, initial discharge of excess PFPE oils to the wellbore may happen due to thermal expansion. However, subsequent loss of PFPE oils to the wellbore through the pothead 45 may be greatly reduced. Neither would there be any ingress of well fluids at the pothead 45.

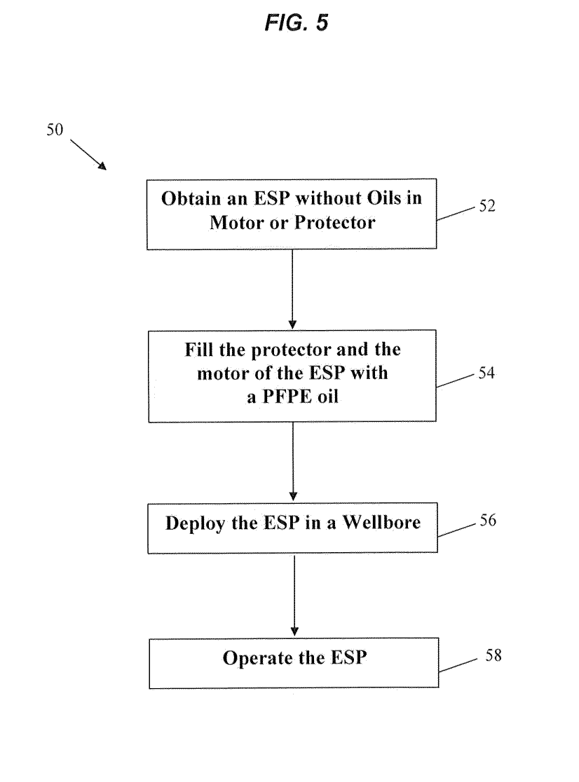

Some embodiments of the invention relate to methods for making and using the pump systems described above. For example, FIG. 5 shows one method for making and using a submersible pump (e.g., an ESP) in accordance with one embodiment of the invention. As shown in FIG. 5, a method 50 for making and using an electrical submersible pump systems in a wellbore may include the following steps: Obtain an ESP without oils filled in the motor and/or protector. (step 52). Then, fill the ESP motor and/or protector with a PFPE oil to produce an ESP of the invention. (step 54). Such an ESP is then deployed in a wellbore for its intended operations. (step 56). Then, the ESP is run to pump a fluid from the wellbore to the surface. (step 58).

Advantages of embodiments of the invention may include one or more of the following. By tilling the motors and/or protectors with PFPE oils in ESP systems, the reliability of such ESP system is increased. At the same time, the operating costs of these systems are reduced because of the extended useful life of the ESP systems at all temperatures. In addition, because of the high specific gravity and immiscibility with well fluids, PFPE oils may be used for straight gravity separation of well fluids in motors and protectors in relatively vertical wells at any temperature. This simplifies the design of protectors. Furthermore, because of the high specific gravity, PFPE oils may be used to exclude well fluids and pressure balance potheads with motors and protectors in relatively vertical wells at any temperature.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. Art electrical submersible pump (ESP) for use in a wellbore, comprising:
a submersible pump;
a motor; and
a protector operatively coupled to the motor to protect the motor, wherein at least one of the motor and protector is filled with a PFPE oil.

2. The ESP of claim 1, wherein the PFPE oil has the following chemical structure:
CF₃CF₂CF₂O—[CF(CF₃)CF₂—O—]ₙCF₂CF₃,
CF₃O—[CF(CF₃)CF₂—O—]_{y}—[CF₂—O—]ₘCF₃,
CF₃O—[CF₂CF₂—O—]_{y}—[CF₂—O—]ₘCF₃, or
CF₃CF₂CF₂O—[CF₂CF₂CF₂—O—]ₙCF₂CF₃,
wherein n is 10-60, and (y+m) is 10-60.

3. The ESP of claim 1, wherein the motor further comprises a pothead attached thereto for connecting a power cable to the motor.

4. The ESP of claim 3, wherein the power cable is protected by a metal tube attached to the pothead, wherein the metal tube extends above a top of the protector.

5. The ESP of claim 4, wherein an annular space between the power cable and the inside of the metal tube is tilled with the PFPE oil.

6. A method for manufacturing an electrical submersible pump (ESP) for use in a wellbore, comprising:
assembling the ESP from a pump, a motor, and a protector, wherein the protector is operatively coupled to the motor for the protection of the motor; and
filling at least one of the motor and protector with a PFPE oil.

7. The method of claim 6, wherein the PFPE oil has the following chemical structure:
CF₃CF₂CF₂O—[CF(CF₃)CF₂—O—]ₙCF₂CF₃,
CF₃O—[CF(CF₃)CF₂—O—]_{y}—[CF₂—O—]ₘCF₃,
CF₃O—[CF₂CF₂—O—]_{y}—[CF₂—O—]ₘCF₃, or
CF₃CF₂CF₂O—[CF₂CF₂CF₂—O—]ₙCF₂CF₃,
wherein n is 10-60, and (y+m) is 10-60.

8. The method of claim 6, wherein the motor comprises a pothead attached thereto for connecting a power cable to the motor, and wherein the power cable is protected by a metal tube, wherein the metal tube extends above a top of the protector and the inside of the metal tube is filled with the PFPE oil.

9. A method for pumping a fluid from a wellbore using an electrical submersible pump (ESP), comprising:
disposing the ESP in the wellbore; and
operating the ESP,
wherein the ESP comprises a pump, a motor, and a protector, and wherein at least one of the motor and protector is filled with a PFPE oil.

10. The method of claim 9, wherein the PFPE oil has the following chemical structure:
CF₃CF₂CF₂O—[CF(CF₃)CF₂—O—]ₙCF₂CF₃,
CF₃O—[CF(CF₃)CF₂—O—]_{y}—[CF₂—O—]ₘCF₃,
CF₃O—[CF₂CF₂—O—]_{y}—[CF₂—O—]ₘCF₃, or
CF₃CF₂CF₂O—[CF₂CF₂CF₂—O—]ₙCF₂CF₃,
wherein n is 10-60, and (y+m) is 10-60.

11. The method of claim 9, wherein the motor comprises a pothead attached thereto for connecting a power cable to the motor, and wherein the power cable is protected by a metal tube, wherein the metal tube extends above a top of the protector and the inside of the metal tube is filled with the ME oil.
